(19) United States
(12) Patent Application Publication
(10) Pub. No.: US 2012/0267427 A1
(43) Pub. Date: Oct. 25, 2012

(54) METHOD AND SYSTEM FOR DISPLAYING INFORMATION FROM A MEMORIAL ASSEMBLY

(75) Inventors: Bryan C. Ahee, Galesburg, IL (US); Brandon J. Bentz, Roseville, IL (US)

(73) Assignee: Brandon Jason Bentz, Roseville, IL (US)

(21) Appl. No.: 13/090,696

(22) Filed: Apr. 20, 2011

(51) Int. Cl. G06F 17/00

(52) U.S. Cl. 235/375

(57) ABSTRACT

A method of displaying information from a memorial assembly. This includes manufacturing a memorial assembly that is associated with an individual, animal, product, or event and during the manufacturing process placing a code into the memorial assembly. A mobile device is then utilized to scan the code such that software within the mobile device can display information associated with the individual for loved ones and others to review.

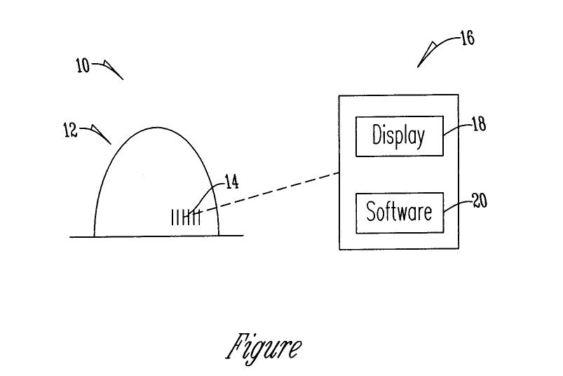

### BACKGROUND OF THE INVENTION

This invention relates to a system and method of displaying information from a memorial assembly. More specifically, this invention relates to the use of an optical machine-readable representation of data such as bar code or RFID tag/label to communicate information about an individual, animal, product, or event to a mobile device.

Memorial assemblies such as memorials, markers, urns, benches, statues, display, mausoleums, emblems, plaques, art, memorabilia, and headstones have long been used to memorialize an individual, animal, product, or event. Such memorial assemblies often have epitaphs or other information regarding the individual, animal, product, or event to provide a history and information to loved ones and additional generations of family members and individuals that are curious about the individual, animal, product, or event. To add to this information, memorial assemblies have been made with display and audio devices that have been integrated into or near the memorial. However, problems exist with such displays and audio devices because they have wiring and components that degrade over time as a result of usage and weather conditions.

Thus, a principal object of the present invention is to provide a memorial information system that does not degrade over time.

Yet another object of the present invention is to provide a method of displaying information from a memorial assembly that is easy and fast to use.

These and other objects, features, or advantages of the present invention will become apparent from the specification and claims.

### BRIEF SUMMARY OF THE INVENTION

A memorial information system that provides a method of displaying information from a memorial assembly. The memorial assembly has an optical machine-readable representation of data such as a bar code or a RFID tab/label either placed upon or marked thereon. A mobile device having software is used to scan the bar code. The mobile device then has a display that displays information about an individual, animal, product, or event associated with the memorial assembly as a result of the scan of the bar code.

### BRIEF DESCRIPTION OF THE DRAWINGS

The FIGURE is a schematic diagram of a memorial information system.

### DETAILED DESCRIPTION OF THE PREFERRED EMBODIMENT

The FIGURE shows a memorial information system 10 that has a memorial assembly 12. The memorial assembly 12 can be any type of structure that is utilized to memorialize an individual, animal, product, or event including but not limited to a memorial, a marker, an urn, a display, a bench, a statue, a mausoleum, an emblem, a plaque, a memorabilia, a monument, a headstone or the like. Placed into the memorial assembly 12 is an optical machine-readable representation of data that in a preferred embodiment is a bar code or RFID tag/label. While preferably a bar code or RFID tag/label is used, any code that may be scanned in order to provide information falls within the scope of this disclosure. The code 14 can be placed upon the memorial assembly, however, in a preferred embodiment the code is marked into the memorial assembly 12 to provide a more esthetically pleasing appearance.

The memorial information system additionally includes a mobile device 16 that includes a display 18 and software 20. The software 20 is capable of scanning the code 14 and communicating with the display 18 to provide or display information encoded in the code 14. In addition, the software 20 is capable of providing over-the-air communication including connection to the internet such that information within the code 14 can be utilized by the software 20 to display information on the display 18 provided by the internet. The mobile device 16 can be a smartphone, iPhone®, iPad®, digital scanner, laptop, tablet computer or the like that is able to scan the code 14 information and provide over-the-air communication and/or access to the internet. Specifically, the code 14 either through information encoded within the code 14 or as a result of being linked or connected to a web page over the internet or other data connection provides digital content on the display 18 that can include but is not limited to real time historical information, genealogy, pictures, videos, voice recordings and the like associated with the individual, animal, product, or event that is associated with the memorial assembly 12.

In operation, when an individual or family member visits a memorial assembly 12 of an individual, animal, product, or event they utilize the mobile device 16 to scan the code 14. As result of scanning the code 14, the display 18 provides information, pictures, videos or the like about the individual, animal, product, or event. Alternatively, a website regarding the individual, animal, product, or event can be displayed.

Thus, provided is a memorial information system 10 that allows an individual to access real time information regarding an individual, animal, product, or event by scanning the memorial assembly 12 with a mobile device 16. Thus the information is always readily available and does not depend on additional wiring, videos or the like that are installed into the memorial assembly that can fray and become worn down after time needing repair. Additionally, the system 10 eliminates costs associated with implementing and constructing such wiring within a memorial assembly 12. Instead the code 14 is marked or placed onto the memorial assembly 12 as part of the manufacturing process. Thus, at the very least all the stated objectives have been met.

It will be appreciated by those skilled in the art that other various modifications could be made to the device without the parting from the spirit and scope of this invention. All such modifications and changes fall within the scope of the claims and are intended to be covered thereby.

1. A method of displaying information from a memorial assembly steps comprising:
manufacturing a memorial assembly;
placing a code into the memorial assembly;
scanning the code placed into the memorial assembly with a mobile device; and
displaying information associated with the code on a display of the mobile device after scanning the code.

2. The method of claim 1 wherein the memorial assembly is selected from the group consisting of grave marker, urn, art, bench, statue, mausoleum, emblem, plaque display, memorabilia, monument and headstone.

3. The method of claim 1 wherein the mobile device is selected from the group consisting of smartphone, iPhone®, iPad®, laptop, tablet computer, and digital scanner.

4. The method of claim 1 wherein the code is an optical machine-readable representation of data.

5. The method of claim 1 wherein the information displayed is associated with genealogy of an individual.

6. The method of claim 1 wherein the information displayed is an audio recording.

7. The method of claim 1 wherein the information is embedded in the code.

8. The method of claim 1 wherein the mobile device has software that retrieves the information over the internet.

9. The method of claim 1 wherein the code is placed onto the memorial assembly.

10. The method of claim 1 wherein the code is marked into the memorial assembly.

11. The method of claim 1 wherein the information is associated with an individual, animal, product or event.

12. A memorial information system comprising:
a memorial assembly having a code; and
a mobile device having software to read the code and display information on a display;
wherein when the mobile device scans the code information is displayed on the display of the mobile device.

13. The system of claim 12 wherein the memorial assembly is selected from the group consisting of grave marker, urn, bench, statue, mausoleum, emblem, plaque, display memorabilia, monument, and headstone.

14. The system of claim 12 wherein the mobile device is selected from the group consisting of smartphone, iPhone®, iPad®, laptop, tablet computer, and digital scanner.

15. The system of claim 12 wherein the information is encoded in the code.

16. The system of claim 12 wherein the software of the mobile device receives the information associated with the individual over the internet.

17. The system of claim 12 wherein the information is associated with an individual, animal, product or event.

18. The system of claim 1 wherein the code is a bar code.

19. The system of claim 1 wherein the code is an RFID tag.
